(19) United States
(12) Patent Application Publication
(10) Pub. No.: US 2014/0372043 A1
(43) Pub. Date: Dec. 18, 2014

(54) Full Waveform Inversion Using Perfectly Reflectionless Subgridding

(71) Applicants: Wenyi Hu, Katy, TX (US); Anatoly Baumstein, Houston, TX (US); John E. Anderson, Houston, TX (US); Carey M. Marcinkovich, The Woodlands, TX (US)

(72) Inventors: Wenyi Hu, Katy, TX (US); Anatoly Baumstein, Houston, TX (US); John E. Anderson, Houston, TX (US); Carey M. Marcinkovich, The Woodlands, TX (US)

(21) Appl. No.: 14/286,107

(22) Filed: May 23, 2014

Related U.S. Application Data
(60) Provisional application No. 61/835,964, filed on Jun. 17, 2013.

(51) Int. Cl. G01V 1/34

(52) U.S. Cl. CPC G01V 1/34
USPC 702/16

(57) ABSTRACT

Method for reconstructing subsurface profiles for seismic velocity or other geophysical properties from recorded seismic data. In one embodiment, a starting model of seismic velocity is assumed (10). The computational domain is divided into two (or more) subdomains by horizontal planes based on an analysis of velocity model (30), and the allowed maximum grid size for each subdomain is determined (50). Auxiliary perfectly matched layers (PML's) are attached to each planar interface between subdomains (80), e.g. two PML's on each side of the interface between the coarse and fine subdomains. Simulated seismic data are computed using the SG-DO technique (100-230). The simulated seismic data are compared to the recorded seismic data, then the residual is calculated (240) and used to update the model (320). The method may be iterated until the model is suitably converged (260).

### CROSS-REFERENCE TO RELATED APPLICATION

This application claims the benefit of U.S. Provisional Patent Application 61/835,964, filed Jun. 17, 2013, entitled Full Waveform Inversion Using Perfectly Reflectionless Subgridding, the entirety of which is incorporated by reference herein.

### FIELD OF THE INVENTION

The invention relates generally to the field of geophysical prospecting and, more particularly, to seismic data processing. Specifically, the invention relates to the technical field of full waveform inversion of seismic data to obtain a velocity or other physical property model using a time-domain algorithm such as finite-difference time domain (“FDTD”) as the forward modeling engine.

### BACKGROUND OF THE INVENTION

Conventional approaches for reconstructing subsurface geophysical property models (e.g., seismic velocity, anisotropy parameters, and attenuation property) are mostly based on a ray tracing method as the forward modeling engine. The main mechanism by which these ray-based techniques can be utilized for estimating the subsurface geophysical properties is that the seismic rays travel from the source, then penetrate the subsurface volume and eventually arrive at the receivers carrying some information of the geophysical properties of the subsurface model. By analyzing the attributes of these recorded seismic traces, one is able to reconstruct the distributions of the subsurface geophysical properties.

For some applications, a ray-based approach can be very efficient and effective. However, for many challenging cases, this category of approaches has limitations that prevent the algorithm from estimating reliable subsurface models of geophysical properties. First, ray tracing methods are only valid if a high frequency assumption is satisfied, which means that ray tracing solutions are inaccurate when the frequencies of the recorded seismic data are relatively low. Second, when the subsurface velocity model is not smooth enough, ray tracing methods are not reliable. Third, ray tracing methods do not preserve the amplitude information precisely, which implies that kinematic information must be used instead of amplitude information for the reconstruction of the subsurface geophysical property models.

Therefore, in recent years, developments in numerical computation techniques motivated research on more advanced approaches for subsurface geophysical property model reconstruction. One of these approaches is called full waveform inversion, which utilizes both the phase and amplitude information in the recorded seismic data to estimate the geophysical properties in the domains through which the seismic waves propagate. In full waveform inversion for subsurface seismic velocity model reconstruction, first, an initial velocity model is generated or otherwise assumed, and a forward modeling is performed to obtain a set of simulated seismic data. Then, the simulated data are compared with the recorded data and the difference between these two sets of data is used to calculate a defined cost function measuring the degree of misfit, sometimes called the residual. Alternatively, the misfit may be measured by correlating the two data sets. After that, the residual (e.g., the difference between the simulated data and the recorded data) is used to drive a direction search to update the subsurface seismic velocity update. The updated velocity model is then input into the forward model to regenerate the simulated seismic data to start a new round of velocity update. This procedure is repeated until the residual is within an acceptable tolerance. This method is the traditional method of inverting a full wavefield, or a partial wavefield, of seismic data to infer a velocity model. In fact, the same basic approach is the traditional method of inferring a subsurface physical property model by inversion of any geophysical data set.

One of the main components in the above method is the forward modeling, whose accuracy determines the reliability of the final reconstructed models of subsurface geophysical properties. In oil and gas industry, the most widely used forward modeling method for full waveform inversion (FWI) is the finite-difference time domain method (FDTD). However, for large scale problems, the finite-difference time domain method is very computationally expensive, especially for cases where velocity variation with depth is substantial and the structure of the velocity model is very irregular.

### SUMMARY OF THE INVENTION

The present invention involves a full waveform inversion, where the conventional forward modeling engine (usually, but not necessarily, a standard FDTD algorithm) is replaced by a perfectly reflectionless subgridding FDTD engine, adapted from the so-called subgridding domain overriding method (SG-DO) (Donderici and Teixeira, 2005), where the computational domain is divided into two or more subdomains and each subdomain uses its own grid size. The interface between these domains are handled by special procedures involving attaching four auxiliary perfectly matched layers (PML's) of grid cells (see also Berenger (1994)) to control the reflection and transmission properties at the interface for the purpose of seamless match between subdomains. With this replacement of the forward modeling engine, one is able to reduce the total number of grids in the whole domain, thus improve the efficiency of the full waveform inversion. In some applications, this computational expense saving can be significant. Because of the computational demands of FWI, the invention is most advantageous in that application; however, it is equally applicable to any inversion of seismic data to infer a velocity or other physical property model.

In one embodiment, the invention is a full waveform inversion method for reconstructing subsurface profiles for seismic velocity or other geophysical properties from recorded seismic data, comprising: (a) generating a starting model of seismic velocity or other geophysical properties; (b) dividing the whole computational domain into two or more subdomains by horizontal planes and determining the allowed maximum grid size for each subdomain; (c) attaching four auxiliary PML layers to each of the planar interfaces between the subdomains; (d) computing simulated seismic data following the procedures in the SG-DO method; (e) comparing the simulated seismic data and the recorded seismic data, calculating the residual, and finding the search direction of velocity update; (f) updating the velocity model or other geophysical property models; and (g) repeat step (b) to (f) with the new model until a suitably converged velocity model or other geophysical property model is obtained.

In another embodiment, the invention is a computer-implemented a method for inferring a subsurface model of velocity or other physical property from seismic data obtained from a seismic survey, comprising: (a) specifying a computational grid for the data inversion, said grid being divided into two subdomains characterized by one subdomain, a coarse grid subdomain, having larger grid cells than the other subdomain, a fine grid subdomain, wherein the two subdomains are separated by an interface called the C-F interface; (b) modifying the computational grid by introducing at least one extra layer, preferably two, into the computational grid on each side of the C-F interface designed such that seismic wave impedances at the C-F interface are matched; and (c) using the modified computational grid and an initial subsurface model of velocity or other physical property to perform, on a computer, numerical inversion of the seismic data to update the initial subsurface model.

The person skilled in the art of parameter estimation by data inversion will recognize that at least some of the steps of the present inventive method are preferably performed on a computer, programmed in accordance with the teachings herein, i.e., the invention is computer implemented in most practical applications.

### BRIEF DESCRIPTION OF THE DRAWINGS

The present invention and its advantages will be better understood by referring to the following detailed description and the attached drawings in which:

FIG. 1 shows a velocity model whose velocity increases with depth; the horizontal line in the middle of the velocity model divides the whole domain into two subdomains: low velocity domain (upper part) and high velocity domain (lower part);

FIG. 2 shows a velocity model discretized by a uniform grid;

FIG. 3 shows a velocity model discretized by grids with different sizes, where the low velocity subdomain (upper part) is discretized by a fine grid, and the high velocity subdomain (lower part) is discretized by a coarse grid;

FIG. 4 shows a velocity model with fine structural features in the shallow part; the whole domain is divided into two subdomains: a fine feature subdomain (shallow part) and a coarse feature subdomain (deep part); the fine feature subdomain is discretized by fine grids while the coarse subdomain is discretized by coarse grids;

FIG. 5 illustrates the domain decomposition in one embodiment of the present invention, where TF, AC, AF, TC are four auxiliary PML layers attached to the C-F interface;

FIG. 6 shows a layout of the regular variables and the auxiliary variables defined in the fine grid subdomain and the coarse grid subdomain;

FIG. 7 shows the layout of the regular variables and the auxiliary variables defined in the auxiliary PML layer AC;

FIG. 8 shows the layout of the regular variables and the auxiliary variables defined in the auxiliary PML layer AF;

FIG. 9 shows the subdomains and all the auxiliary PML layers stitched together;

FIG. 10 is a flowchart showing basic steps in one embodiment of the present inventive method for full waveform inversion based on perfectly reflectionless subgridding FDTD;

FIG. 11A shows the geometry and parameter setting of the subgridding FDTD simulation for a first test example of the present inventive method;

FIG. 11B shows a snapshot of the pressure field p at time 0.32 s using the traditional FDTD method with a uniform grid in the whole domain to be used as the reference solution (for display purposes, only the field in the fine grid subdomain is presented);

FIG. 11C shows a snapshot of the pressure field p at time 0.32 s using the conventional subgridding FDTD method based on interpolation and decimation;

FIG. 11D shows a snapshot of the pressure field p at time 0.32 s using the perfectly reflectionless subgridding FDTD method of the present invention;

FIG. 12A shows a snapshot of the pressure field p at time 12 s using the conventional subgridding FDTD method based on interpolation and decimation at the C-F interface;

FIG. 12B shows a snapshot of the pressure field p at time 12 s using the perfectly reflectionless subgridding FDTD method of the present invention;

FIG. 13A shows the geometry and parameter setting for subgridding FDTD simulation in a second test example of the present inventive method;

FIG. 13B shows a snapshot of the pressure field p at time 0.32 s using the standard FDTD method with uniform grid in the whole domain to be used as the reference solution (for display purpose, only the field in the fine grid subdomain is presented);

FIG. 13C shows a snapshot of the pressure field p at time 0.32 s using the conventional subgridding FDTD method based on interpolation and decimation; and

FIG. 13D shows a snapshot of the pressure field p at time 0.32 s using the perfectly reflectionless subgridding FDTD method of the present invention.

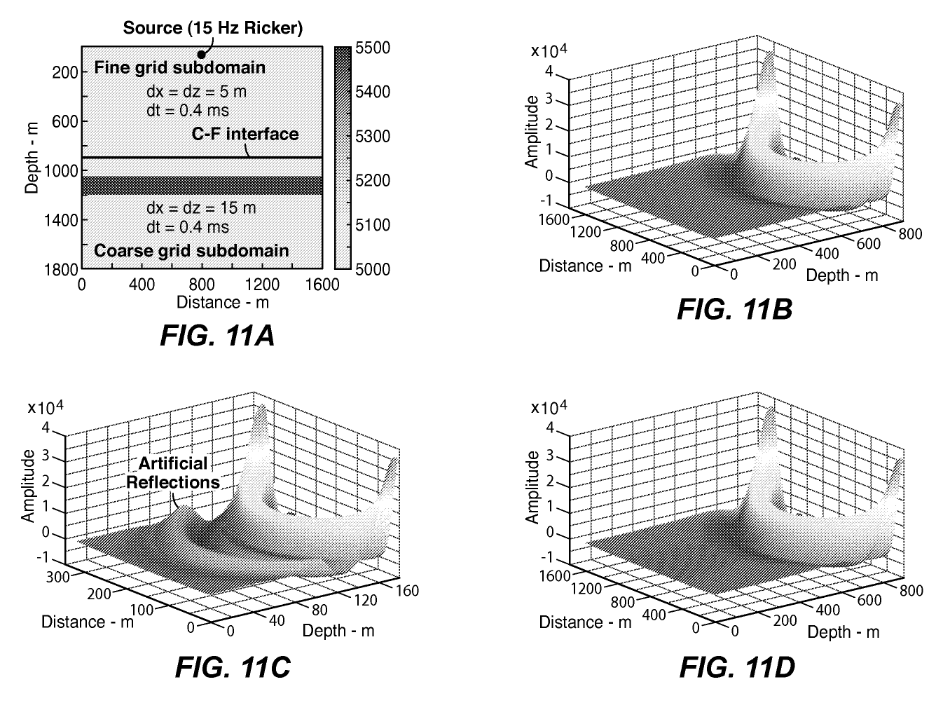

Due to patent rule restrictions on the use of color in drawings, FIGS. 11A-11D, 12A-12B, and 13A-13D are black-and-white reproductions of drawings in which pressure is quantitatively represented on a color scale.

The invention will be described in connection with example embodiments. However, to the extent that the following detailed description is specific to a particular embodiment or a particular use of the invention, this is intended to be illustrative only, and is not to be construed as limiting the scope of the invention. On the contrary, it is intended to cover all alternatives, modifications and equivalents that may be included within the scope of the invention, as defined by the appended claims.

### DETAILED DESCRIPTION OF EXAMPLE EMBODIMENTS

The present invention includes a method for reconstruction of 2D or 3D seismic velocity model or other geophysical property models from recorded seismic data, a technical field that may be called full waveform inversion. As disclosed below, a perfectly reflectionless subgridding finite-difference time domain method may be used to replace the conventional finite-difference time domain method to significantly improve the efficiency and the accuracy of the full waveform inversion method. This method can be used as described in the following two examples, which are not intended to be limiting.

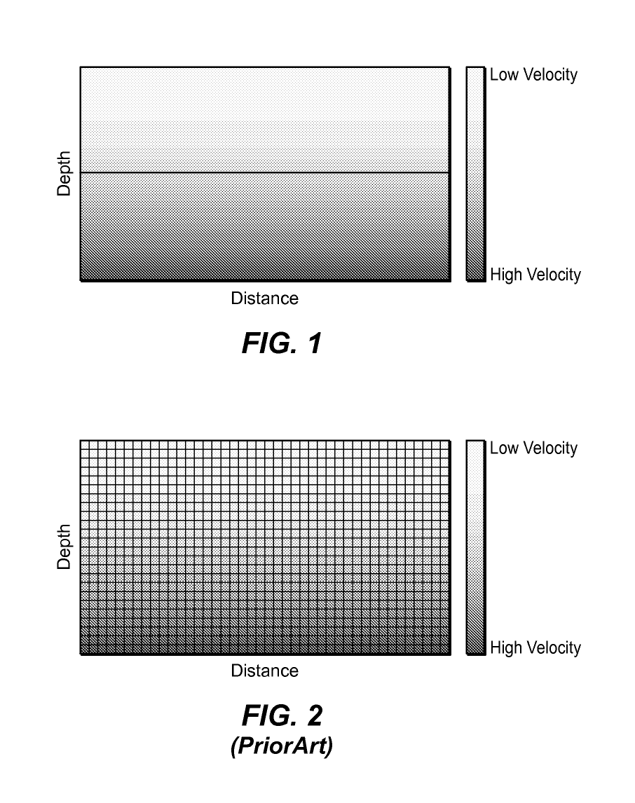

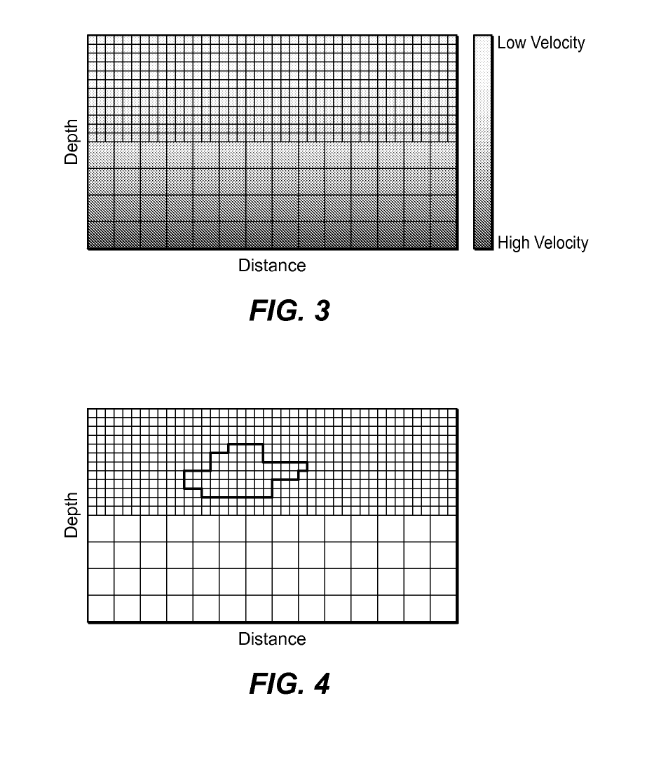

The first example is a velocity model whose velocity increases with depth, as shown in FIG. 1, where velocity is indicated by the darkness of the shading according to the scale on the right. The horizontal line in the middle of the velocity model domain is the interface between a low velocity subdomain (upper part) and a high velocity subdomain (lower part). With the standard FDTD method, the grid size is uniform in the whole computational domain, as shown in FIG. 2. The maximum usable grid size is determined by the frequency band of the seismic data, the user's accuracy requirement, and the minimum velocity in the whole computational domain. If the frequency band and the accuracy requirement are fixed, then the allowed maximum grid size is dictated by the minimum seismic velocity in the velocity model. The larger the maximum grid size, the more efficient the algorithm is. Consequently, to improve efficiency in situations such as the velocity model where the velocity increases with depth, the present inventive method uses what may be called a “subgridding FDTD” method, where the whole domain is divided into two subdomains, as shown in FIG. 3. In the low velocity subdomain, fine grid is used, while in the high velocity subdomain, coarse grid is used. If the minimum velocity in the high velocity subdomain is three times of that in the low velocity subdomain, then three times larger grids can be used in the high velocity subdomain.

In the second example, whose velocity model is shown in FIG. 4, the structure in the shallow part has fine features. However, in the deep part, there is no fine structure. Consequently, even though there is no significant velocity variation in the whole computational domain, to resolve the fine features in the shallow part, a fine grid has to be used in the whole domain with the standard FDTD method. On the other hand, with subgridding FDTD, again, the whole domain can be divided into two subdomains: the fine feature subdomain (upper part) and the coarse feature subdomain (lower part). In the fine feature subdomain, the fine grids are used to resolve those fine features and in the coarse feature subdomain, coarse grids may be used.

Unfortunately, most existing subgridding FDTD methods suffer from artificial reflection and instability at the fine-coarse grid interface. In this invention, a perfectly reflectionless subgridding FDTD method is used to avoid these critical issues and to ensure the successful implementation of full waveform inversion while improving the efficiency substantially. It is the so-called the subgridding domain overriding method (SG-DO). See the 2005 Donderici and Teixeira reference, which is incorporated herein by reference in all jurisdictions that allow it.

Donderici and Teixeira basically took the existing subgridding FDTD method and applied the four auxiliary perfectly matched layers (PML's) from Berenger to deal with spurious reflections and instabilities, computational in nature, caused by the transition from one grid scale to another. However, it should be noted that Donderici and Teixeira are working with electromagnetic waves, which are transverse waves, rather than acoustic (seismic) waves, which are longitudinal waves. So they are solving Maxwell's equations by numerical methods, and they assume that the resistivity model for the subsurface is known. They never update the model to match simulated data to measured data. The 1994 Berenger paper is also an electromagnetic wave modeling study. Despite these differences, there are similarities in all wave behavior, and the present inventors have adapted the SG-DO approach to solving the acoustic wave propagation equation, and applied it to inversion of seismic data to update (improve) an assumed subsurface velocity model.

Next, the invention will be described in more detail. Basic features of the present invention in at least some of its embodiments are as follows. A starting seismic velocity model is generated. The source and receiver geometry information is collected, and the source waveform is estimated. The velocity model is analyzed and divided into two or more subdomains, and each subdomain is assigned a specific grid size, i.e. the cell size in each grid subdomain is specified. This domain decomposition will preferably be constrained by a numerical simulation accuracy requirement and a model spatial resolution requirement. At each coarse-fine grid interface (C-F interface) between the subdomains, four auxiliary perfectly matched layers (PML) are attached to be used as the buffers for wave decomposition and wave recombination. The decomposed velocity model, the source receiver geometry information, and the source waveform are input into the subgridding domain overriding (SG-DO) finite-difference time domain algorithm to obtain simulated seismic data that corresponds to, i.e. predicts, the measured seismic data. The residual may be calculated by subtracting the recorded seismic data from the corresponding data values in the simulated seismic data. This residual volume may be utilized to calculate the gradient of the current seismic velocity model (in model parameter space) through an adjoint method. The seismic velocity may be updated according to the calculated gradient combined with a line search algorithm. The updated seismic velocity model may then be used to generate another set of simulated seismic data for the next round of seismic velocity model updating until the residual is within some preselected error tolerance.

Some underlying theory of the invention is explained next.

As described above, the seismic velocity model is decomposed into two or more layers (subdomains), and then each subdomain is gridded, with the grid sizes for these subdomains being different to take advantage of the capability to reduce the total number of cells in the whole computational domain. The interfaces, often but not necessarily horizontal (horizontal lines for two-dimensional cases and horizontal planes for three-dimensional cases), between these subdomains are called coarse-fine grid interface (C-F interface). For simplicity, only two-dimensional scenarios will be described in this disclosure. However, extension to three-dimensional cases is straightforward.

There are at least two approaches to this domain decomposition. In the first approach, with the assumption that there is no fine structural feature to resolve, the domain is decomposed into high velocity subdomain and low velocity subdomain, as shown in FIG. 1, where the upper part is the low velocity subdomain, the lower part is the high velocity subdomain, and the horizontal line is the C-F interface. If the minimum velocities are vₗₘ and vₕₘ for the low velocity subdomain and the high velocity subdomain respectively, the maximum frequency of the source waveform is fₘ (which corresponds to a minimum wavelength), and the maximum number of grid points per (minimum) wavelength allowed by the amount of numerical dispersion that can be tolerated is n_{g}, then the low velocity subdomain is gridded with the fine grid size

$${Δ}_{f} = \frac{{v}_{lm}}{{f}_{m} {n}_{g}}$$

and the high velocity subdomain is gridded with the coarse grid size

$${Δ}_{c} = \frac{{v}_{hm}}{{f}_{m} {n}_{g}} ,$$

as shown in FIG. 3 (note the Δ_{c}/Δ_{f} is not necessarily an integer). In the second approach to domain decomposition, the domain is decomposed into fine structure subdomain and coarse structure subdomain with the minimum velocities as v_{fm} and v_{cm} respectively. In each of the subdomains, the grid size (Δ_{f} or Δ_{c}) may be determined by the finest feature of the velocity model structure instead of by the minimum velocity. To meet the accuracy requirement, the final grid size for the fine structure subdomain is

$$min ( \frac{{v}_{fm}}{{f}_{m} {n}_{g}} , {Δ}_{f} )$$

and the grid size for the coarse structure subdomain is

$$min ( \frac{{v}_{cm}}{{f}_{m} {n}_{g}} , {Δ}_{c} ) .$$

Here, Δ_{f} and Δ_{c} are determined by the finest feature of the velocity model structure, as illustrated in FIG. 4.

Regarding dispersion, which is effectively an unwanted noise coming out of a numerical simulation, the dispersion increases as the grid gets coarser and decreases as the order of the numerical finite difference scheme increases. So to control dispersion, one can either make the grid smaller or increase the order of the finite difference scheme being used.

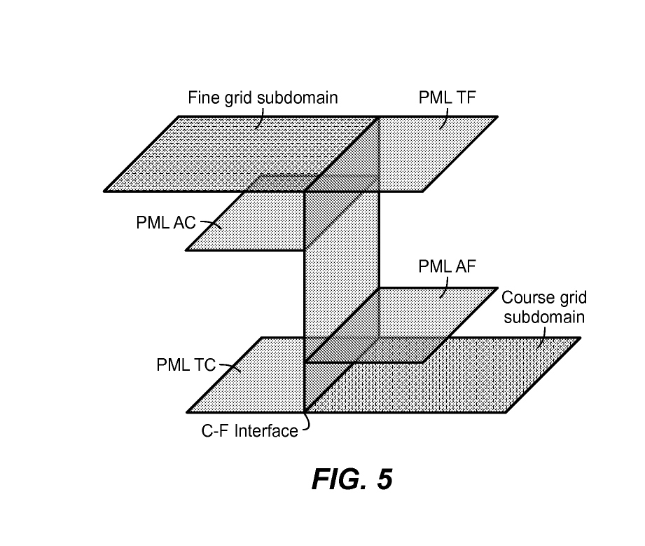

The next step is attaching the auxiliary perfectly matched layers (PML) to the C-F interface. As shown in FIG. 5, there are four auxiliary PML layers attached to the C-F interface. They are TF, AC, AF, and TC. The thickness of the PMLs is determined by the artificial reflection suppression requirements (usually one or two wavelengths should be enough for most applications). TF and AC layers have the same grid size as the fine grid subdomain while TC and AF layers have the same grid size as the coarse grid subdomain.

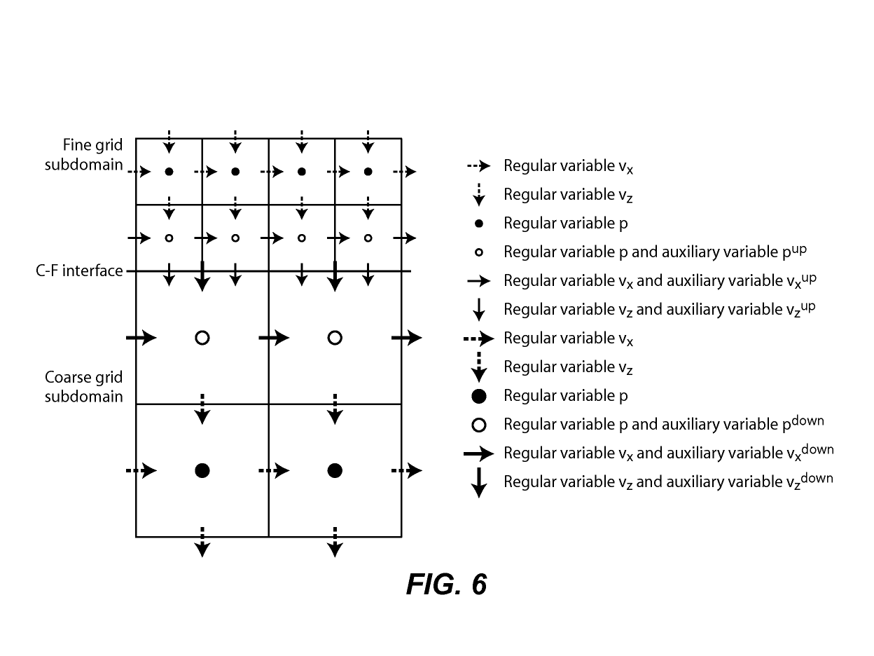

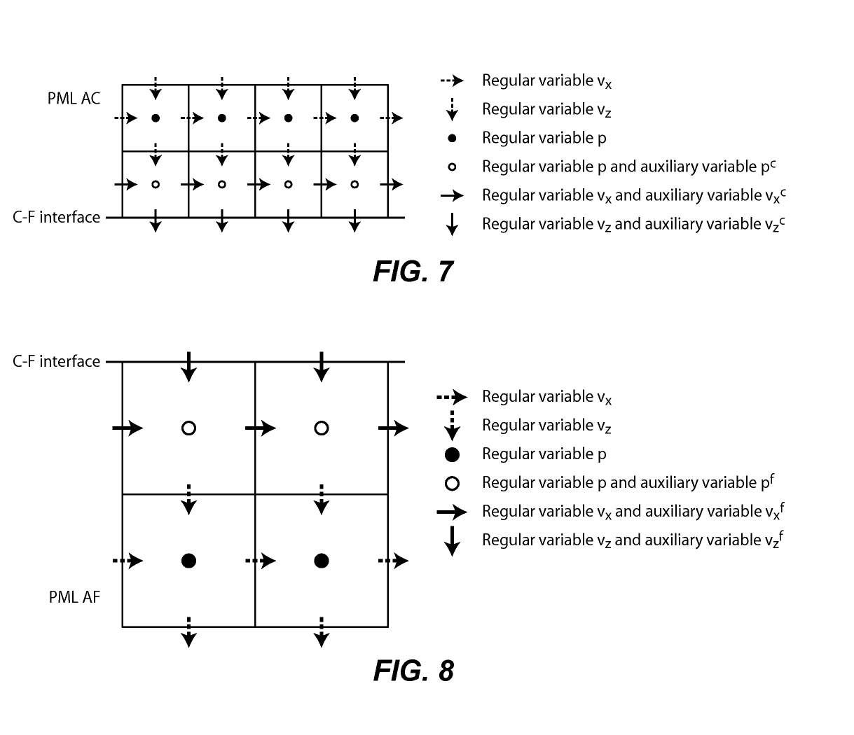

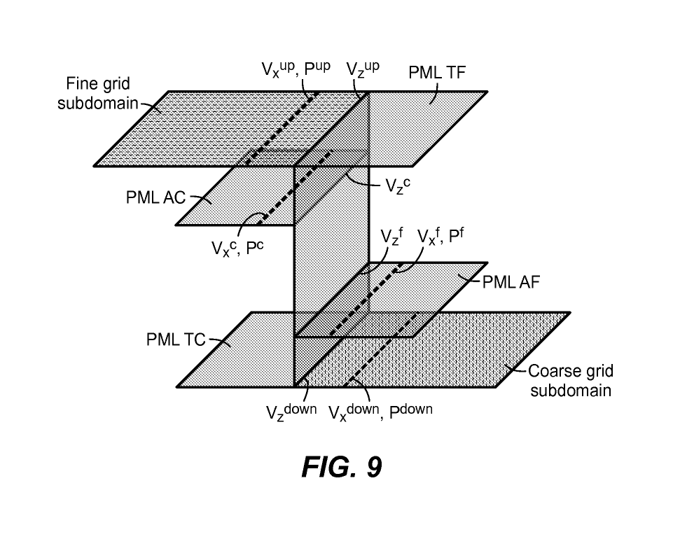

The mechanism of this perfectly reflectionless subgridding FDTD algorithm is based on wave decomposition and wave recombination. That is, the total wave at C-F interface is decomposed into incoming wave towards the interface and the outgoing wave and later the incoming wave and the outgoing wave are recombined after passing through the C-F interface. By doing this, the computational medium discontinuity introduced by the C-F interface is bypassed through the domain extension with the four auxiliary PML layers. A preferred procedure for implementing this wave decomposition and wave recombination is as follows (see FIG. 6).
(1) In the fine grid subdomain, besides the regular variables (pressure field p and particle velocities vₓ and vₓ) defined in conventional FDTD methods, introduce the auxiliary variables p^{up}, vₓ^{up}, and v_{z}^{up}. In the coarse grid subdomain, introduce the auxiliary variables p^{down}, vₓ^{down}, and v_{z}^{down}. The layout of these regular variables and the auxiliary variables is shown in FIG. 6. In the auxiliary PML layer AC, introduce the auxiliary variables p^{c}, vₓ^{c}, and v_{z}^{c}. The layout of the regular variables and the auxiliary variables is shown in FIG. 7. In the auxiliary PML layer AF, introduce the auxiliary variables p^{f}, vₓ^{f}, and v_{z}^{f}. The layout of the regular variables and the auxiliary variables is shown in FIG. 8. The subdomains and the auxiliary PML layers are stitched together as shown in FIG. 9.
(2) Update the regular variables vₓ and v_{z} in all the subdomains and the auxiliary PMLs using the conventional FDTD methods.
(3) Update v_{z}^{up} using the conventional FDTD methods but p^{up} is replaced by (p^{up}−p^{c}) in the update equation.
(4) Update v_{z}^{down} using the conventional FDTD methods but p^{down} is replaced by (p^{down}−p^{f}) in the updated equation.
(5) Decimate v_{z}^{up} to obtain v_{z}^{f}.
(6) Interpolate v_{z}^{down} to obtain v_{z}^{c}.
(7) Update the regular variables p in all the subdomains and the auxiliary PMLs using the conventional FDTD methods.
(8) Update p^{up} using the conventional FDTD methods but v_{z}^{up} is replaced by (v_{z}^{up}+v_{z}^{c}) in the update equation.
(9) Update p^{down} using the conventional FDTD methods but v_{z}^{down} is replaced by (v_{z}^{down}+v_{z}^{f}) in the update equation.
(10) Go to (1) to start the next time step until the simulation is finished.

Regarding decimation and interpolation, and how the two differ: In the case of a uniform finite difference grid, which is typical, one could simply apply a multi-dimensional Fast Fourier Transform (FFT) to transform the data from “space” to “wavenumber” domain. In order to decimate the data, one would zero out higher Fourier coefficients corresponding to the wavenumbers that could not be represented on a coarse grid, then perform inverse FFT of shorter length, so that the output corresponds to data located on a coarser grid. In the case of interpolation, one would pad with zeros in the wavenumber domain, then perform inverse FFT of increased length, so that the output corresponds to data located on a finer grid. There are numerous alternative interpolation/decimation methods. The one based on the FFT is the most accurate, but also the slowest.

Decimation and interpolation can also apply to the time axis if different time steps are used in the fine grid and coarse grid domains. Adapting the most efficient time step to each domain can improve computational efficiency.

In most subgridding FDTD methods, the fine grid subdomain and the coarse grid subdomain are terminated by each other or by a buffer area. The communication between the fine grid subdomain and the coarse subdomain or the buffer area is mainly based on interpolation and decimation, which cannot prevent the wave impedance mismatching at the C-F interface. As a result, artificial reflections (numerical reflections) at the C-F interface are inevitable and the reflection coefficients are dependent on the grid size ratio between the subdomains. For large grid size ratio, artificial reflections can be a serious problem and ruin simulation results severely. Late time instability arising at the C-F interface is a usual phenomenon observed in most subgridding FDTD methods. In contrast to that, in the perfectly reflectionless subgridding FDTD method, both the fine grid subdomain and the coarse grid subdomain are directly terminated by the auxiliary PML layers, which means that the wave impedances at the C-F interface are perfectly matched. Therefore, the numerical reflection rate at the C-F interface can be suppressed down to PML reflection levels (usually ˜60 to 80 dB). The proper communication between the subdomains is realized by wave decomposition and wave recombination performed at the C-F interface following the procedure described earlier.

The seismic wave propagation equivalent of numerical impedance matching done by Donderici and Teixeira (2005) for the electromagnetic wave propagation case might be Schoenberg-Muir (1989) media averaging to match the wave propagation parameters in the coarse grid domain to the parameters in the fine grid domain. This is useful to ensure that phase velocities match properly between the two grids at the C-F interface.

After the FDTD simulation results are obtained using the perfectly reflectionless FDTD method, the recorded seismic data and the simulated seismic data are used to calculate the residual. The residual is injected into the model to calculate the gradient (i.e., the derivative of the velocity model or other geophysical properties model to be reconstructed) by using the perfectly reflectionless FDTD method. (FWI gradient computation comprises propagating the source pulse forward in time and propagating the residual backward in time, i.e. two applications of the FDTD simulator, both incorporating the reflectionless subgridding procedure of the present invention.) With a line search algorithm, an appropriate step length is calculated to ensure a monotonically reducing data residual. The step length and the gradient are combined to update the velocity model or other geophysical property models.

Next, the current model is replaced by the updated velocity model (or other updated geophysical property models), analyze, and the process is iterated: decompose, and discretize the newly updated model, rerun the perfectly reflectionless subgridding FDTD algorithm to obtain a new set of simulated seismic data, and then repeat the workflow described above to update the velocity model (or other geophysical property model) until the data residual is within the predefined error tolerance or the reconstructed models (e.g., the models for V_{P}, V_{S} and ρ or I_{P}) meet other preselected iteration convergence requirements, or another stopping condition is reached.

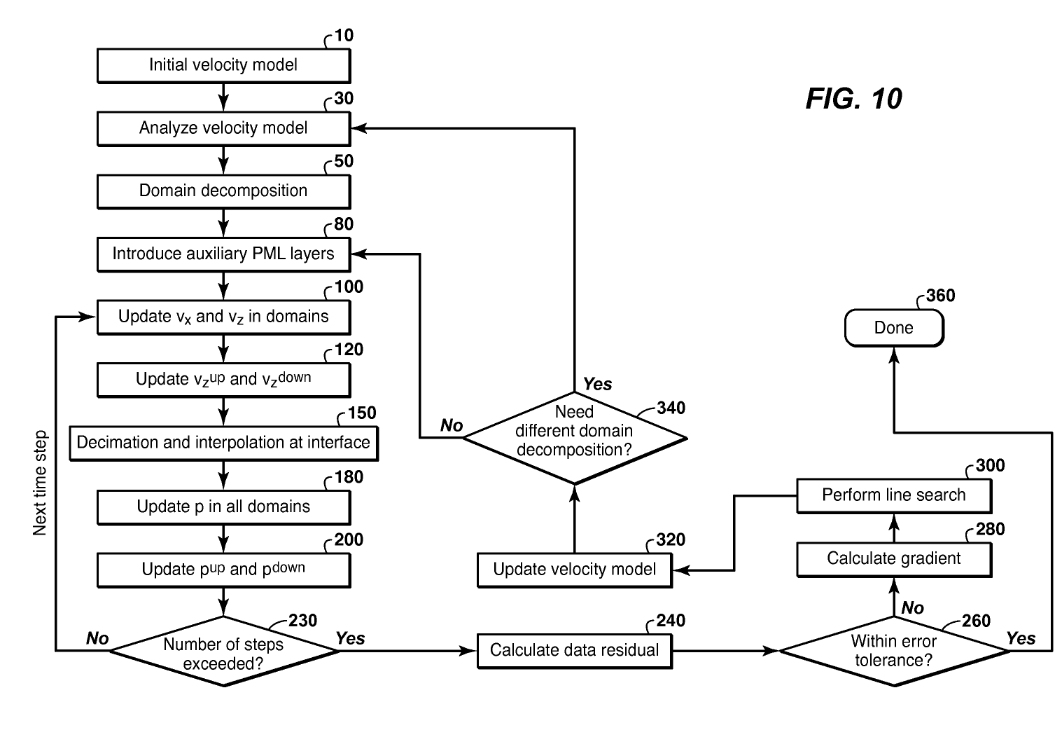

In one of its embodiments, the present invention can be implemented according to the flow chart shown in FIG. 10. In steps 30 and 50, the initial velocity model 10 is analyzed and decomposed. The decomposed velocity model will consist of two or more subdomains and each subdomain is discretized with its specific grid size, which may be selected to balance iteration convergence and resolution with computer running time considerations. The initial velocity model 10, as well as its update 320, refer to the speed of sound as a function of location in the subsurface medium, which can be different in different propagation directions when the medium is anisotropic, e.g. a layered medium. This speed of sound (or the related quantity, acoustic impedance) is/are the inversion unknown(s) for which the FWI is trying to invert.

In step 80, the four auxiliary PML layers (AC, AF, TC, and TF), or their functional equivalent, are introduced and attached to each C-F interface. In step 100, the regular P-wave velocity variable(s), for example particle velocity components vₓ and v_{z}, are updated in all the subdomains and all the auxiliary PML layers by using the conventional FDTD methods. (Note that vₓ and v_{z} denote particle velocity of the wavefield and not the inversion unknown, speed of sound.) If this were the first iteration of the inversion process, there would be no update; the velocity model assumed initially would be used. To understand the update, one needs to look at the step 320 in the flowchart. For any cycle of the iteration except the first, the update from step 320 is what is used at step 100. In step 120, v_{z}^{up} is updated using the conventional FDTD methods but p^{up} is replaced by (p^{up}−p^{c}) in the updated wave equation; v_{z}^{down} is updated using the conventional FDTD methods but p^{down} is replaced by (p^{down}−p^{f}) in the updated wave equation. In step 150, v_{z}^{up} is decimated to obtain v_{z}^{f} and v_{z}^{down} is interpolated to obtain v_{z}^{c}. In step 180, the pressure field p is updated in all the subdomains and all the auxiliary PML layers using the conventional FDTD methods. In step 200, p^{up} is updated using the conventional FDTD methods but v_{z}^{up} is replaced by (v_{z}^{up}+vz^{c}); p^{down} is updated using the conventional FDTD methods but v_{z}^{down} is replaced by (v_{z}^{down}+vz^{f}). A check is made in step 230 to determine whether the simulation is finished. If not, the algorithm goes back to step 100 to start the next time step. (In the FDTD method, the time variable is broken up into a number of discrete time steps, and the partial differential equation needs to be numerically solved at each time step). Otherwise, the simulated seismic data are input into step 240 to calculate the data residual. In step 260, if the data residual is within a predefined error tolerance, then the velocity model reconstruction process finishes. Otherwise, the gradient is calculated in step 280 and the line search is performed in step 300 to obtain a step length to ensure that the data residual is reducing during the full waveform inversion process. In step 320, the velocity model is updated by using the calculated gradient and the obtained step length. In step 340, another judgment may be made to determine whether different domain decomposition and gridding strategy are required. If so, the process returns to step 30. If the current domain decomposition and gridding strategy is suitable for the updated velocity model, the process may return to step 80.

### EXAMPLES

In this section, numerical examples are presented to show that the perfectly reflectionless subgridding FDTD method gives accurate solutions while being immune to artificial reflections and late time instability problems, which leads to a significantly more efficient full waveform inversion without sacrificing the quality of reconstructed velocity models or other geophysical property models.

The seismic velocity model and the parameter setting for the first example of subgridding FDTD simulation are shown in FIG. 11A. The velocity model consists of a homogeneous background velocity of 5000 m/s and an embedded reflector with the velocity of 5500 m/s located between the depth of 1050 m and the depth of 1200 m. First, a standard FDTD simulation is performed with a uniform grid size of 5 m and the snapshot of the pressure field p in the upper subdomain at time of about 0.32 s is shown in FIG. 11B, which may be used as the reference solution. (Using a fine grid throughout requires more computation than subgridding, but the results may be assumed to be accurate.) The source is a Ricker wavelet with the dominant frequency of 15 Hz. Then, a conventional subgridding FDTD method based on interpolation and decimation at the C-F interface (the SG-DO method with the PML's will be discussed next) is performed and the snapshot of the pressure field p at time of 0.32 s is shown in FIG. 11C, where strong artificial reflections are observed. In this subgridding FDTD simulation, the grid size in the fine grid subdomain is 5 m and that in the coarse grid subdomain is 15 m. FIG. 11D shows the simulation result of the perfectly reflectionless subgridding FDTD method of the present invention, which is almost identical to the reference solution confirming the advantages and effectiveness of the present invention.

In this example, the subdomains are based neither on structural features nor on velocity differences. The only structural feature is the embedded reflector, and it was put in the coarse grid subdomain. However, this example stands for the point that there can be other circumstances where subgridding can be advantageous. For example, one might want to have a finer grid around sources and receivers, even if they are located in a homogeneous medium.

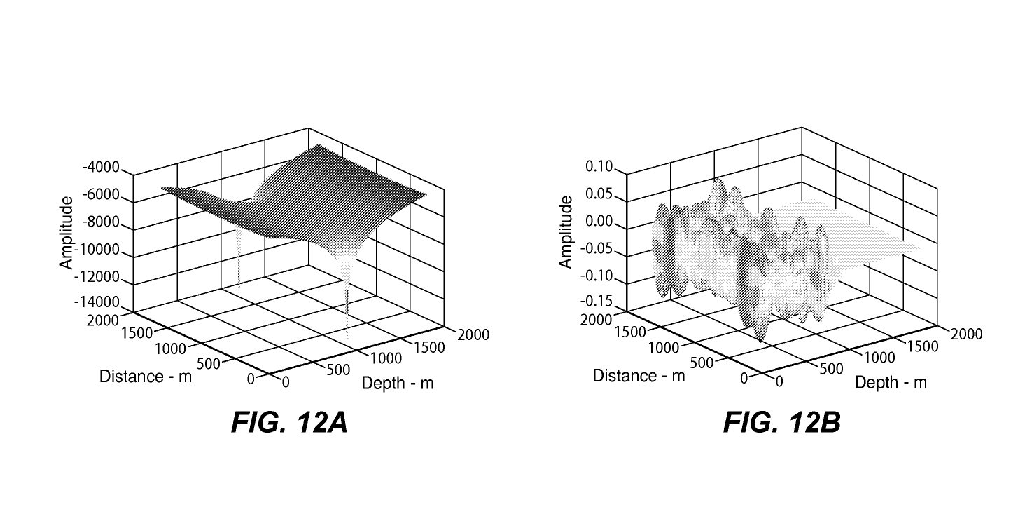

To test the late stability performance of the subgridding FDTD methods, the simulation was rerun for time=12 s (12 seconds after the seismic source shot). By this time, all reverberations will have died out. However, numerical instability manifests itself as unbounded growth in the solution amplitude as a function of simulation time. This can be seen in the simulation result of the conventional subgridding FDTD method based on interpolation and decimation is shown in FIG. 12A, where the instability phenomenon is observed at the C-F interface (the two downward spikes). On the other hand, there is no late stability issue in the simulation results generated by the perfectly reflectionless subgridding FDTD method, as shown in FIG. 12B.

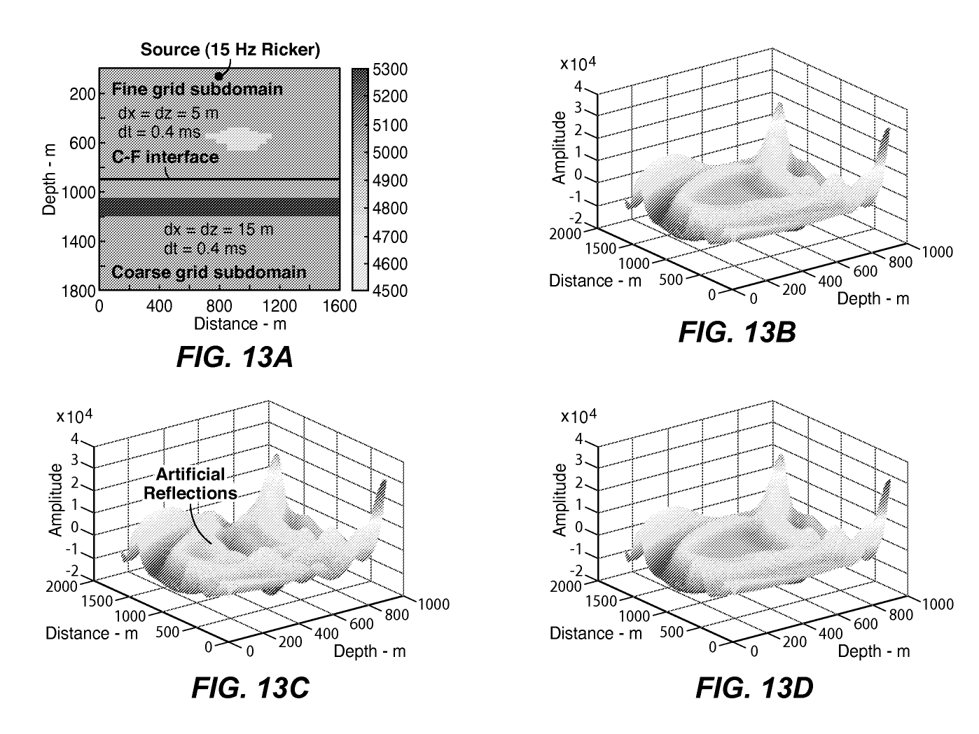

In the second numerical simulation example, as shown in FIG. 13A, a low-velocity anomaly with fine structural features is embedded in the upper subdomain, in addition to the same deeper, high-velocity anomaly (which does not have fine structural features) that was used in the velocity model 11A. Due to the fine structural features of the shallow anomaly, fine grids need to be used in the upper subdomain to preserve the simulation accuracy, while coarse grids can be used in the lower subdomain to improve the efficiency. Therefore, the grid size in the upper subdomain is 5 m and the grid size in the lower subdomain is 15 m. Again, the standard FDTD simulation with the uniform grid size of 5 m is performed to be used as the reference solution and the simulation result, the snapshot of the pressure field p (down to 1000 m) at time of 0.36 s, is shown in FIG. 13B. FIG. 13C shows the pressure field p snapshot at 0.36 s by using the conventional subgridding FDTD method based on interpolation and decimation at the C-F interface, where the artificial reflections ruin the simulation results. In sharp contrast, the simulation result of the perfectly reflectionless subgridding FDTD shown in FIG. 13D is indistinguishable from the reference solution of FIG. 13B.

The foregoing description is directed to particular embodiments of the present invention for the purpose of illustrating it. It will be apparent, however, to one skilled in the art, that many modifications and variations to the embodiments described herein are possible. For example, the invention has been explained mostly in the context of a FDTD technique for the numerical simulation. However, the invention will work for a full range of time-stepping simulators including (a) time-domain finite difference (TDFD); (b) time-domain finite element (FE); (c) time-domain discontinuous Galerkin (DG); and (d) time-domain spectral element simulators (SPECFM). The invention includes any of these simulators, or any combination of them, for example between earth model regions using the invention to gain either (a) efficiency and/or (b) resolution for either simulation or FWI inversion. In another possible variation, the sub-gridding region boundaries in the examples given herein tend to be planar but could be non-planar, in which case the inventive method could include multi-physics (e.g., acoustic in water layer, elastic in sediment, etc.); see, for example, Gao and Zhang (2008). All such modifications and variations are intended to be within the scope of the present invention, as defined by the appended claims.

### REFERENCES

Donderici, B. and F. L. Teixeira, “Improved FDTD subgridding algorithms via digital filtering and domain overriding,” IEEE Transactions on Antenna and Propagation 53, 2938-2951 (2005).
Berenger, J. P., “A perfectly matched layer for the absorption of electromagnetic waves,” J. Comput. Phys. F14, 195-200 (1994). This reference is incorporated herein by reference in all jurisdictions that allow it.
Etgen, J. T. and O'Brien, J., “Computational methods for large-scale 3D acoustic finite-difference modeling: A tutorial,” Geophysics 72(5), SM223-SM230 (2007).
Gao, H. and Zhang, J., “Implementation of perfectly matched layers in an arbitrary geometrical boundary for elastic wave modeling,” http://gji.oxfordjournals.org/content/174/3/1029.full (2008).
Schoenberg, Michael and Francis Muir, “A calculus for finely layered anisotropic media,” Geophysics 54, 581-589 (1989).

1. A computer-implemented method for inferring a subsurface model of velocity or other physical property from seismic data obtained from a seismic survey, comprising:
specifying a computational grid for the data inversion, said grid being divided into two subdomains characterized by one subdomain, a coarse grid subdomain, having larger grid cells than the other subdomain, a fine grid subdomain, wherein the two subdomains are separated by an interface called the C-F interface;
modifying the computational grid by introducing at least one extra layer into the computational grid on each side of the C-F interface designed such that seismic wave impedances at the C-F interface are matched;
using the modified computational grid and an initial subsurface model of velocity or other physical property to perform, on a computer, numerical inversion of the seismic data to update the initial subsurface model.

2. The method of claim 1, wherein the numerical conversion is iterative, and the model is updated for each new cycle of the iteration, said updated model being used in a next cycle of the iteration until a preselected convergence criterion is satisfied, or other stopping condition is met.

3. The method of claim 2, wherein the model is used to generate synthetic seismic data and an objective function is defined to measure degree of misfit between the synthetic seismic data and the seismic data obtained from a seismic survey, and the objective function is computed and used to generate an update to the model.

4. The method of claim 3, wherein two extra layers are added on each side of the C-F interface and the design of the extra layers is based on wave decomposition and wave recombination.

5. The method of claim 4, wherein the generating synthetic seismic data comprises numerically solving a wave propagation equation for pressure and particle velocity as a function of position and time in the subsurface, which comprises mathematically constructing a seismic wave and propagating it through the subsurface, and the wave at the C-F interface is decomposed into an incoming wave towards the interface and an outgoing wave moving away from the interface, and later the incoming wave and the outgoing wave are recombined after passing through the C-F interface, thereby bypassing a computational medium discontinuity introduced by the C-F interface, by virtue of the extra layers added on each side of the CF interface in the computational grid.

6. The method of claim 5, wherein numerically solving the wave propagation equation comprises using a finite difference, time domain technique.

7. The method of claim 5, wherein the wave decomposition and recombination comprises interpolation or decimation of velocity components.

8. The method of claim 3, where the model update is generated using a gradient of the objective function in model parameter space.

9. The method of claim 3, further comprising determining an allowed maximum grid cell size for each subdomain.

10. The method of claim 9, wherein a source waveform is assumed in order to generate the synthetic seismic data, and the determination of the allowed maximum grid cell size for each subdomain is based on minimum velocity in each subdomain and maximum frequency of the source waveform.

11. The method of claim 1, further comprising defining at least one additional subdomain, thereby dividing the specified computational grid into at least three subdomains having at least two C-F interfaces, wherein each CF interface is modified in the computational grid by introducing extra layers into the computational grid on each side of the C-F interface designed such that seismic wave impedances at the C-F interface are perfectly matched.

12. The method of claim 1, wherein the subsurface is inhomogeneous in terms of the velocity or other physical property, and the fine grid subdomain is characterized by lower values of velocity or the other physical property, and the coarse grid subdomain is characterized by higher values of velocity or the other physical property.

13. The method of claim 1, wherein the fine grid subdomain includes one or more fine structural features of the subsurface.

14. The method of claim 1, wherein the seismic data being inverted consists of a full wavefield of seismic data.

15. The method of claim 1, wherein the C-F interface is a horizontal plane.
